(19) United States
(12) Patent Application Publication
(10) Pub. No.: US 2025/0029487 A1
(43) Pub. Date: Jan. 23, 2025

(54) REAL-TIME TRAFFIC MANAGEMENT USING SMART TRAFFIC SIGNALS

(71) Applicant: Charter Communications Operating, LLC, St. Louis, MO (US)

(72) Inventors: Vishal G. Chopade, Castle Pines, CO (US); Mohamed Daoud, Aurora, CO (US); Hany A. Heikal, Aurora, CO (US)

(21) Appl. No.: 18/353,539

(22) Filed: Jul. 17, 2023

(51) Int. Cl. G08G 1/081

(52) U.S. Cl. CPC G08G 1/081

(57) ABSTRACT

A computing device may receive traffic data from a plurality of traffic signals. The computing device may determine an action for each traffic signal of the plurality of traffic signals to take based on the traffic data. The computing device may send, to the plurality of traffic signals, instructions corresponding to the action for each traffic signal of the plurality of traffic signals to take.

### BACKGROUND

Traffic congestion on roads can cause problems, such as delays for drivers and hindering the ability of first responders to quickly arrive at a destination. Traffic signals may not receive accurate traffic information to be able to re-route the traffic to reduce delays when roads are congested.

### SUMMARY

The examples disclosed herein perform real-time traffic management using smart traffic signals by using real-time data from traffic signals to reduce delays for users and optimize traffic flow. Real-time data may be received from the traffic signals by a central computing system. The real-time data may be used by the central computing system to determine an action for the traffic signals to take, such as changing light colors to improve traffic flow. Instructions that correspond to the action, such as instructions as to what color to change a light, can be sent from the central computing device to the traffic signals in order for the traffic signals to take the action.

In one example, a method for real-time traffic management using smart traffic signals is provided. The method includes receiving, by a central computing device, traffic data from a plurality of traffic signals. The method further includes determining, by the central computing device, an action for each traffic signal of the plurality of traffic signals to take based on the traffic data. The method further includes sending, by the central computing device to the plurality of traffic signals, instructions corresponding to the action for each traffic signal of the plurality of traffic signals to take.

In another example, a computing device for real-time traffic management using smart traffic signals is provided. The computing device includes a memory and a processor device coupled to the memory. The processor device is to receive traffic data from a plurality of traffic signals. The processor device is further to determine an action for each traffic signal of the plurality of traffic signals to take based on the traffic data. The processor device is further to send, to the plurality of traffic signals, instructions corresponding to the action for each of traffic signal of the plurality of traffic signals to take.

In another example, a non-transitory computer-readable storage medium for real-time traffic management using smart traffic signals is provided. The non-transitory computer-readable storage medium includes computer-executable instructions to cause a processor device to receive traffic data from a plurality of traffic signals. The instructions further cause the processor device to determine an action for each traffic signal of the plurality of traffic signals to take based on the traffic data. The instructions further cause the processor device to send, to the plurality of traffic signals, instructions corresponding to the action for each traffic signal of the plurality of traffic signals to take.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing system in which examples of real-time traffic management using smart traffic signals may be practiced;

FIG. 2 is a flowchart illustrating operations performed by the computing system of FIG. 1 for real-time traffic management using smart traffic signals, according to one example;

FIG. 3 is a block diagram of the computing system of FIG. 1 for real-time traffic management using smart traffic signals, according to one example;

FIG. 4 is a block diagram of the computing system of FIG. 1 for real-time traffic management using smart traffic signals, according to one example;

FIG. 5 is a block diagram of the computing system of FIG. 1 for real-time traffic management using smart traffic signals, according to one example; and

FIG. 6 is a block diagram of a computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the elements unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Traffic congestion on roads can cause problems, such as delays for drivers and hindering the ability of first responders to quickly arrive at a destination. Traffic signals may not receive accurate traffic information to be able to re-route the traffic to reduce delays when roads are congested.

The examples disclosed herein perform real-time traffic management using smart traffic signals by using real-time data from traffic signals to reduce delays for users and optimize traffic flow. A central computing system may receive real-time data from the traffic signals that is associated with the traffic on the roads where the traffic signals operate. The real-time data can be used by the central computing system to determine an action for the traffic signals to take, such as changing light colors to improve traffic flow.

The central computing system may determine the action for the traffic signals to take by using a machine-learning model, images taken by cameras associated with the traffic signals, and vehicle speed information obtained by sensors associated with the traffic signals. The machine-learning model may determine, based on the images and/or the vehicle speed information, an amount of current traffic congestion and use the amount of current traffic congestion to determine the action for the traffic signals to take in order to reduce the traffic congestion. The machine-learning model may also generate a route to avoid and alleviate the traffic congestion and the action may be based on the route.

Instructions can be generated by the central computing system, such as by the machine-learning model, that correspond to the action, such as instructions as to what color to change a light. The central computing system may send the instructions to the traffic signals in order for the traffic signals to take the action. As a result, traffic congestion and delays for drivers can be reduced in real-time. Processing the traffic data and generating information by the central computing system allows for increased scalability and reduced downtime risks, and can be accomplished without on-premise hardware installation, such as when the central computing system is cloud-based.

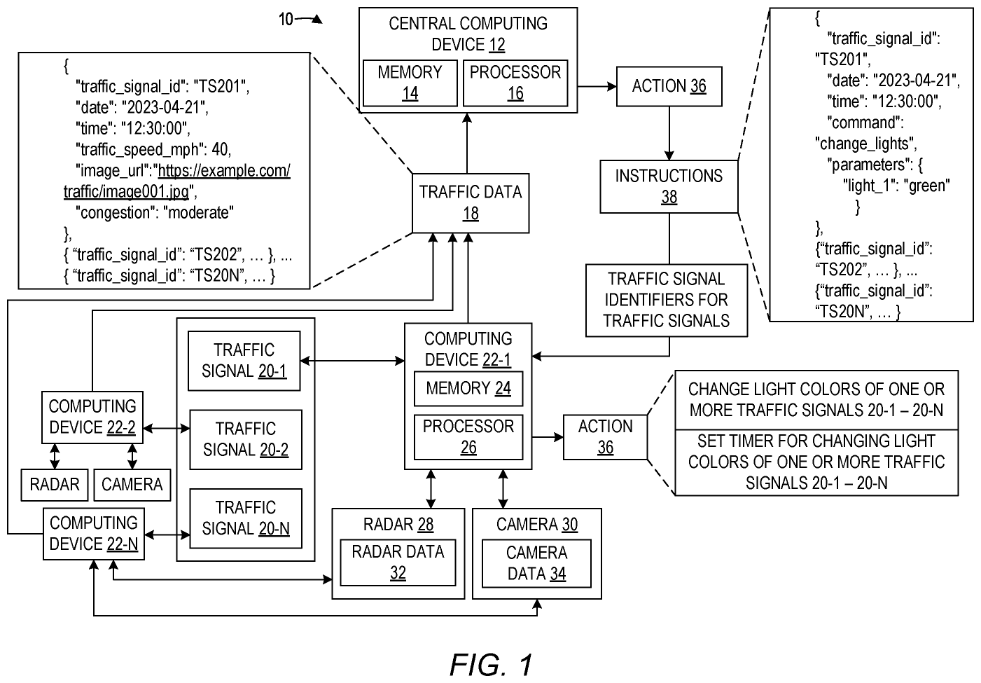

FIG. 1 is a block diagram of a computing system 10 in which examples of real-time traffic management using smart traffic signals may be practiced. The computing system 10 includes a central computing device 12 that comprises a memory 14 and a processor device 16. Although only the central computing device 12 is illustrated with a memory 14 and a processor device 16, any component of the computing system 10 may include one or more memories 14 and/or one or more processor devices 16. It is to be understood that the computing system 10 in some examples may include constituent elements in addition to those illustrated in FIG. 1. In examples where the central computing device 12 comprises software instructions that program the processor device 16 to carry out functionality discussed herein, functionality implemented by the central computing device 12 may be attributed herein to the processor device 16. The central computing device 12 may be a cloud computing device, a server device, an edge device, or any other type of computing device that is centralized and communicates with other computing devices via one or more networks.

In the example of FIG. 1, the central computing device 12 may receive traffic data 18 from a plurality of traffic signals 20-1-20-N (collectively, traffic signals 20). Prior to the central computing device 12 receiving the traffic data 18, the traffic signals 20 may obtain the traffic data 18 via computing devices 22 (e.g., computing device 22-1) that are communicatively coupled to the traffic signals 20 (e.g., traffic signal 20-1). Each traffic signal of the traffic signals 20 may be communicatively coupled to a computing device of the computing devices 22. In some implementations, the computing devices 22 may be attached to the traffic signals 20 or proximate to the traffic signals 20 and able to communicate wirelessly with the traffic signals 20 via a network. The computing devices 22 each comprise a memory 24 and a processor device 26. The computing devices 22 can be communicatively coupled to a radar device 28 and a camera 30. In some implementations, the radar device 28 and the camera 30 may be attached to a traffic signal from among the traffic signals 20 or proximate to one or more traffic signals from among the traffic signals 20 and able to communicate over a network wirelessly with the computing devices 22 that are communicatively coupled to the traffic signals 20. Each of the computing devices 22 communicatively coupled to each traffic signal of the traffic signals 20 may communicate with a radar device and a camera associated with the computing device (e.g., the computing device 22-2 can be communicatively coupled to a radar and camera) or with a radar device and a camera that are associated with more than one of the computing devices 22 (e.g., the computing device 22-1 and the computing device 22-N can be communicatively coupled to the radar device 28 and the camera 30).

The traffic data 18 may be based on radar data 32, such as vehicle speeds, collected by the radar device 28 and camera data 34, such as images, collected by the camera 30. For instance, the traffic data 18 may be based on the radar data 32 collected by the radar device 28 and the camera data 34 collected by the camera 30, and the radar device 28 and the camera 30 may be associated with one or more traffic signals from among the traffic signals 20, such as when the radar device 28 and the camera 30 are communicatively coupled to the computing device that is communicatively coupled to the one or more traffic signals. The traffic data 18 may be sent by the computing devices 22 to the central computing device 12 over a network, such as a private LTE or 4G network as non-limiting examples. The traffic data 18 may include at least one of a traffic signal identifier or id number associated with a traffic signal from among the traffic signals 20, a current date and a current time, such as the date and time at which the traffic data 18 was collected or sent over the network, a traffic speed (e.g., the average speed of the vehicles driving on the road), a traffic image URL to a location where the traffic image is stored, and a traffic congestion level. The traffic data 18 may, in some examples, be in the form of a JSON (JavaScript Object Notation) that includes the traffic signal identifier, date, time, traffic speed, traffic image URL, and traffic congestion level associated with the traffic signals 20.

The central computing device 12 may determine an action 36 for each traffic signal of the traffic signals 20 to take based on the traffic data 18. For instance, the central computing device 12 may use machine learning to determine the amount of traffic congestion on the roads or at an intersection associated with the traffic signals 20 based on the traffic data 18, and use the amount of traffic congestion to determine the action 36 for each traffic signal of the traffic signals 20. The central computing device 12 may generate instructions 38 that correspond to the action 36 for a traffic signal of the traffic signals 20 to take. The action 36 may be to change a light color of the traffic signal or to set a timer for changing the light color of the traffic signal, as non-limiting examples. In some implementations, the instructions 38 may be stored in a data structure of the central computing device 12 or a data structure of the computing system 10.

The central computing device 12 may send to the traffic signals 20 (e.g., to the computing devices 22), the instructions 38 corresponding to the action 36 for each traffic signal of the traffic signals 20 to take. The central computing device 12 may determine a traffic signal identifier for each traffic signal of the traffic signals 20 based on the traffic data 18. For instance, the traffic data 18 may use a unique number or character sequence to identify each traffic signal of the traffic signals 20 and the unique number or character sequence can be the traffic signal identifier so that the instructions 38 can be sent to the correct traffic signal of the traffic signals 20. When sending the instructions 38, the central computing device 12 may send the instructions 38 to a traffic signal of the traffic signals 20 based on the traffic signal identifier for the traffic signal and include the traffic signal identifier in the instructions 38 so that the instructions 38 are sent to the correct traffic signal. In embodiments where the instructions 38 are stored in a data structure, the central computing device 12 may retrieve the instructions 38 from the data structure, such as by a query with the traffic signal identifier for the traffic signal, prior to sending the instructions 38 to the traffic signals 20. The instructions 38 may be a JSON with a traffic signal identifier that identifies a traffic signal of the traffic signals 20 to send the instructions 38 to, a current date and a current time, the action 36 or command for the traffic signal to take, and the instructions 38 or parameters that describe how the action 36 is to be accomplished, as non-limiting examples.

After the central computing device 12 sends the instructions 38 to the traffic signals 20, the computing devices 22 may perform the action 36 based on the instructions 38. The central computing device 12 may send the instructions 38 that correspond to the action 36 to a computing device of the computing devices 22 that is communicatively coupled to a traffic signal of the traffic signals 20 based on a traffic signal identifier. The computing device (e.g., the computing device 22-1) may then perform the action 36 as identified in the instructions 38. For example, the action 36 may be to change the lights of a traffic signal, the instructions 38 may identify the particular traffic signal by a traffic signal identifier and include the color to change the light of the traffic signal to, and the computing device may change the color of the light of the traffic signal to the color identified in the instructions 38 by running a function that corresponds to the action 36 to change the lights with the parameters that are identified in the instructions 38 with the color to change the lights.

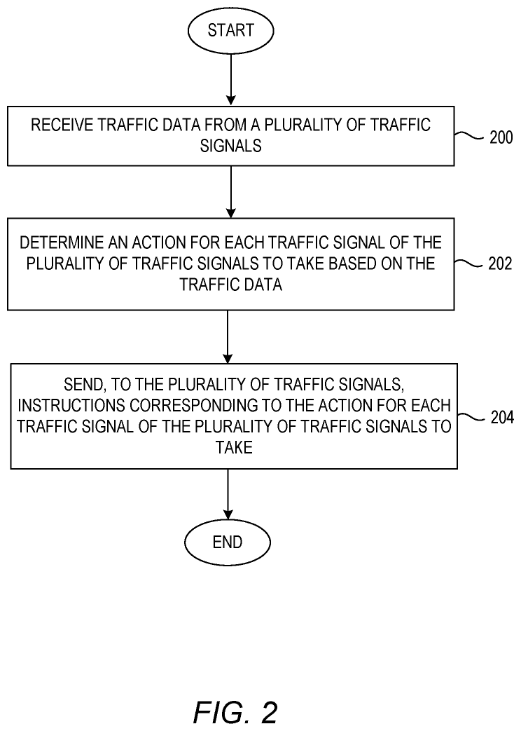

FIG. 2 is a flowchart illustrating operations performed by the computing system of FIG. 1 for real-time traffic management using smart traffic signals, according to one example. Elements of FIG. 1 are referenced in describing FIG. 2 for the sake of clarity. In FIG. 2, operations begin with a processor device of a computing device, such as the processor device 16 of the central computing device 12 of FIG. 1, the processor device 16 to receive the traffic data 18 from the plurality of traffic signals 20 (block 200). The processor device 16 is further to determine the action 36 for each traffic signal of the plurality of traffic signals 20 to take based on the traffic data 18 (block 202). The processor device 16 is further to send, to the plurality of traffic signals 20, instructions 38 corresponding to the action 36 for each traffic signal of the plurality of traffic signals 20 to take (block 204).

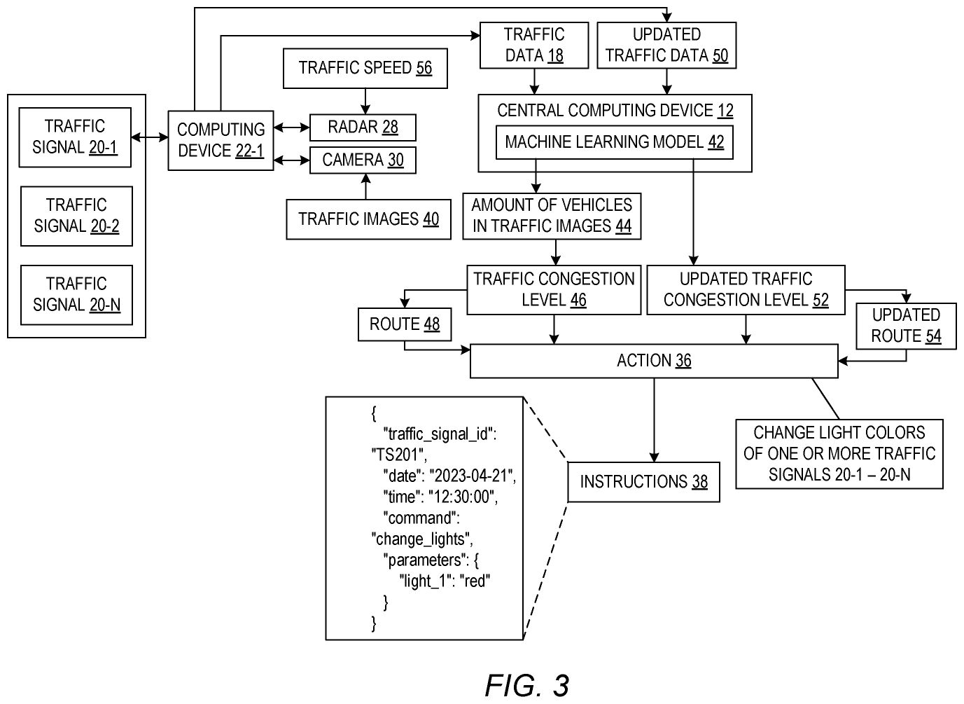

FIG. 3 is a block diagram of the computing system of FIG. 1 for real-time traffic management using smart traffic signals, according to one example. Elements of FIG. 1 are referenced in describing FIG. 3 for the sake of clarity. In the example of FIG. 3, the central computing device 12 may determine the action 36 for each traffic signal of the traffic signals 20 to take by obtaining traffic images 40 from the traffic data 18. The traffic images 40 may correspond to a traffic signal of the traffic signals 20. For instance, the traffic data 18 may identify traffic signal 20-1 with a traffic signal identifier and include the traffic images 40 associated with the traffic signal 20-1, such as images taken by the camera 30, by providing a link to a location where the traffic images 40 are stored and can be retrieved by the central computing device 12. The central computing device 12 may include a machine-learning model 42 that is trained on traffic images and prior traffic data from the traffic signals 20. The machine-learning model 42 can determine an amount of vehicles 44 in the traffic images 40, such as by counting the number of vehicles in the traffic images 40 or identifying outlines of vehicles and road lines, as non-limiting examples. The machine-learning model 42 can determine a traffic congestion level 46 based on the amount of vehicles 44 in the traffic images 40. The traffic congestion level 46 may be a metric, such as a number or percentage that identifies an amount of traffic congestion on the roads, or a rating or grouping, such as “low,” “moderate,” or “high,” as non-limiting examples.

The action 36 can be based on the traffic congestion level 46. For example, the traffic congestion level 46 may be “high” and the action 36 may be to change the color of the lights of the traffic signals 20 that are near the highly congested area in order to move traffic through the area. The central computing device 12, such as by the machine-learning model 42, can determine based on the traffic congestion level 46 that the action 36 for each traffic signal of the traffic signals 20 to take is to change the light colors of one or more of the traffic signals 20. The central computing device 12, such as by the machine-learning model 42, can generate the instructions 38 to send to each traffic signal of the traffic signals 20 (e.g., to the computing devices 22) and the instructions 38 can include a command to change the lights of a traffic signal (i.e., the action 36), a traffic signal identifier that identifies the traffic signal to change the lights, and the color to change the light of the traffic signal.

In some implementations, the central computing device 12, such as by the machine-learning model 42, may generate a route 48 based on the traffic data 18 and the traffic congestion level 46. For example, the traffic data 18 may identify intersections that are blocked, the traffic congestion level 46 may be “moderate,” and the central computing device 12 may generate the route 48 to go around the blocked intersections and the moderate traffic. The central computing device 12 may generate the route 48 and determine that the action 36 is to change the light colors of one or more of the traffic signals 20 in order to follow the route 48. The central computing device 12, such as by the machine-learning model 42, can generate the instructions 38 to send to each traffic signal of the traffic signals 20 (e.g., to the computing devices 22) based on the route 48. For instance, the instructions 38 for the traffic signals 20 that are to change light colors in order to follow the route 48 can include a command to change the lights (i.e., the action 36) and the color to change the light. In some implementations, the instructions 38 can include a time for each traffic signal of the traffic signals 20 in the route 48 to change light colors and the color to change the light at that time in order to follow the route 48 and reduce traffic congestion. In some embodiments, the central computing device 12, such as by the machine-learning model 42, may generate the route 48 in response to receiving information from an emergency vehicle or a computing device associated with the emergency vehicle, such as from a dispatcher, about a location of the emergency vehicle and an address of the emergency vehicle's destination. The central computing device 12 may generate the route 48 to clear a path for the emergency vehicle to quickly get to the destination and the central computing device 12 can determine that the traffic signals 20 along the route 48 are to take the action 36 of changing to green lights and generate the instructions 38 to send to the traffic signals 20 to change the light colors to green.

The central computing device 12 may determine the action 36 for each traffic signal of the traffic signals 20 to take by obtaining a traffic speed 56 from the traffic data 18. The traffic speed 56 may correspond to a traffic signal of the traffic signals 20. For instance, the traffic data 18 may identify traffic signal 20-1 with a traffic signal identifier and include the traffic speed 56 associated with traffic signal 20-1, such as speeds of vehicles taken by the radar device 28. The machine-learning model 42 of the central computing device 12 can determine the traffic congestion level 46 based on the traffic speed 56. For example, a traffic speed below the speed limit for the road where the traffic signal is located may indicate a higher traffic congestion level than when the traffic speed is at or above the speed limit. The action 36 can be based on the traffic congestion level 46. The central computing device 12, such as by the machine-learning model 42, can determine based on the traffic congestion level 46 that the action 36 for each traffic signal of the traffic signals 20 to take is to change the light colors of one or more of the traffic signals 20. The central computing device 12, such as by the machine-learning model 42, can generate the instructions 38 to send to each traffic signal of the traffic signals 20 (e.g., to the computing devices 22) and the instructions 38 can include a command to change the lights of a traffic signal (i.e., the action 36), a traffic signal identifier that identifies the traffic signal to change the lights, and the color to change the light of the traffic signal. In some implementations, the central computing device 12, such as by the machine-learning model 42, may generate the route 48 based on the traffic data 18 and the traffic congestion level 46 that was determined based on the traffic speed 56, determine that the action 36 is to change the light colors of one or more of the traffic signals 20 in order to follow the route 48, and generate the instructions 38 to send to each traffic signal of the traffic signals 20 based on the route 48.

In some embodiments, the central computing device 12 may determine the action 36 for each traffic signal of the traffic signals 20 to take by obtaining the traffic images 40 and the traffic speed 56 from the traffic data 18. The traffic images 40 and the traffic speed 56 may both correspond to a traffic signal of the traffic signals 20. The machine-learning model 42 can determine the amount of vehicles 44 in the traffic images 40, and determine the traffic congestion level 46 based on the amount of vehicles 44 in the traffic images 40 and the traffic speed 56. For example, a high number of vehicles in the traffic images and a speed of the vehicles below the speed limit in the area where the traffic signal that the traffic data corresponds to is located may indicate that there is a high traffic congestion. The action 36 can be based on the traffic congestion level 46. The central computing device 12, such as by the machine-learning model 42, can determine based on the traffic congestion level 46 that the action 36 for each traffic signal of the traffic signals 20 to take is to change the light colors of one or more of the traffic signals 20. The central computing device 12, such as by the machine-learning model 42, can generate the instructions 38 to send to each traffic signal of the traffic signals 20 (e.g., to the computing devices 22) and the instructions 38 can include a command to change the lights of a traffic signal (i.e., the action 36), a traffic signal identifier that identifies the traffic signal to change the lights, and the color to change the light of the traffic signal. In some implementations, the central computing device 12, such as by the machine-learning model 42, may generate the route 48 based on the traffic data 18 and the traffic congestion level 46 that was determined based on the amount of vehicles 44 in the traffic images 40 and the traffic speed 56, determine that the action 36 is to change the light colors of one or more of the traffic signals 20 in order to follow the route 48, and generate the instructions 38 to send to each traffic signal of the traffic signals 20 based on the route 48.

The central computing device 12 may receive updated traffic data 50 from the traffic signals 20 and determine an updated traffic congestion level 52 based on the updated traffic data 50. For instance, the central computing device 12 can obtain new or updated traffic images and/or new or updated traffic speeds, the machine-learning model 42 can determine an amount of vehicles in the updated traffic images, and the machine-learning model 42 can determine the updated traffic congestion level 52 based on the amount of vehicles in the new or updated traffic images and/or the new or updated traffic speeds. In some implementations, the central computing device 12, such as by the machine-learning model 42, can generate an updated route 54 based on the updated traffic data 50 and the updated traffic congestion level 52. The central computing device 12 may generate the updated route 54 and then determine that the action 36 is to change the light colors of one or more of the traffic signals 20 in order to follow the updated route 54. The central computing device 12, such as by the machine-learning model 42, can generate the instructions 38 to send to each traffic signal of the traffic signals 20 (e.g., to the computing devices 22) based on the updated route 54 For instance, the instructions 38 for the traffic signals 20 that are to change light colors in order to follow the updated route 54 can include a command to change the lights (i.e., the action 36) and the color to change the light. In some implementations, the instructions 38 can include a time for each traffic signal of the traffic signals 20 in the updated route 54 to change light colors and the color to change the light at that time in order to follow the updated route 54 and reduce traffic congestion.

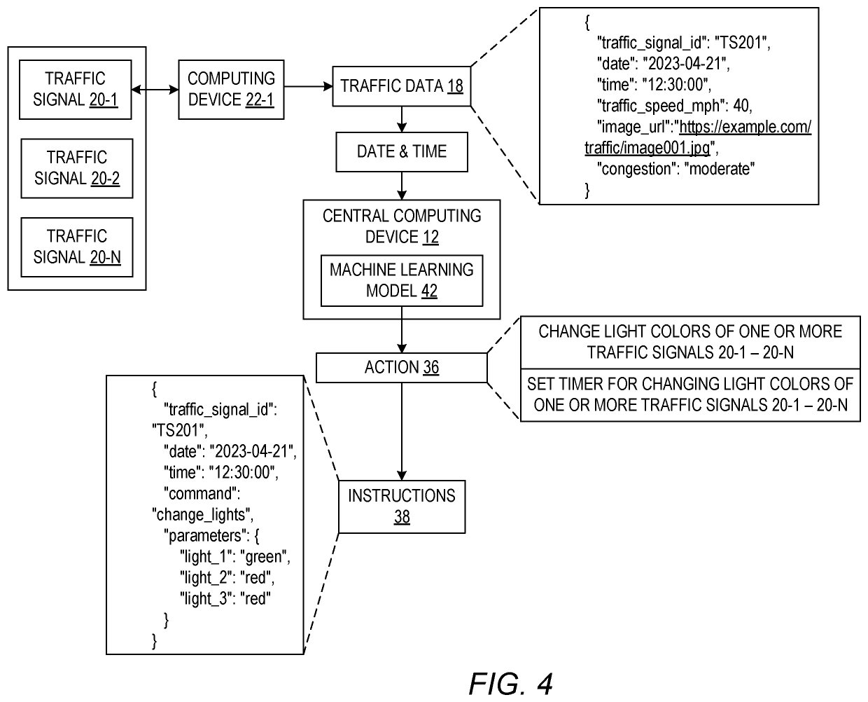

FIG. 4 is a block diagram of the computing system of FIG. 1 for real-time traffic management using smart traffic signals, according to one example. Elements of FIG. 1 are referenced in describing FIG. 4 for the sake of clarity. In the example of FIG. 4, the central computing device 12 may determine the action 36 for each traffic signal of the traffic signals 20 to take by obtaining a current date and a current time from the traffic data 18. The machine-learning model 42 may be trained on prior traffic data from the traffic signals 20 that identifies traffic congestion levels at different days and times, and the machine-learning model 42 may learn the actions to take during specific days and at specific times as a result of the prior traffic pattern history. The machine-learning model 42 can then determine the action 36 for each traffic signal of the traffic signals 20 to take based on the current date and the current time. For example, the machine-learning model 42 may have learned based on prior traffic data from the traffic signals 20 that the traffic congestion level 46 is high from 7:00 a.m. to 10:00 a.m. on Mondays at traffic signal 20-1 and traffic signal 20-2. In order to reduce traffic congestion, the machine-learning model 42 may determine that the current date is a Monday and the current time is 8:00 a.m., determine that the action 36 for traffic signal 20-1 and traffic signal 20-2 to take is to change the lights to green, and generate the instructions 38 for traffic signal 20-1 and traffic signal 20-2 to change lights to green in real-time. The instructions 38 may also include timings for the lights based on the date and time, such as keeping a traffic signal light green for a longer time before turning the light red during times with high traffic congestion levels predicted based on the machine-learning.

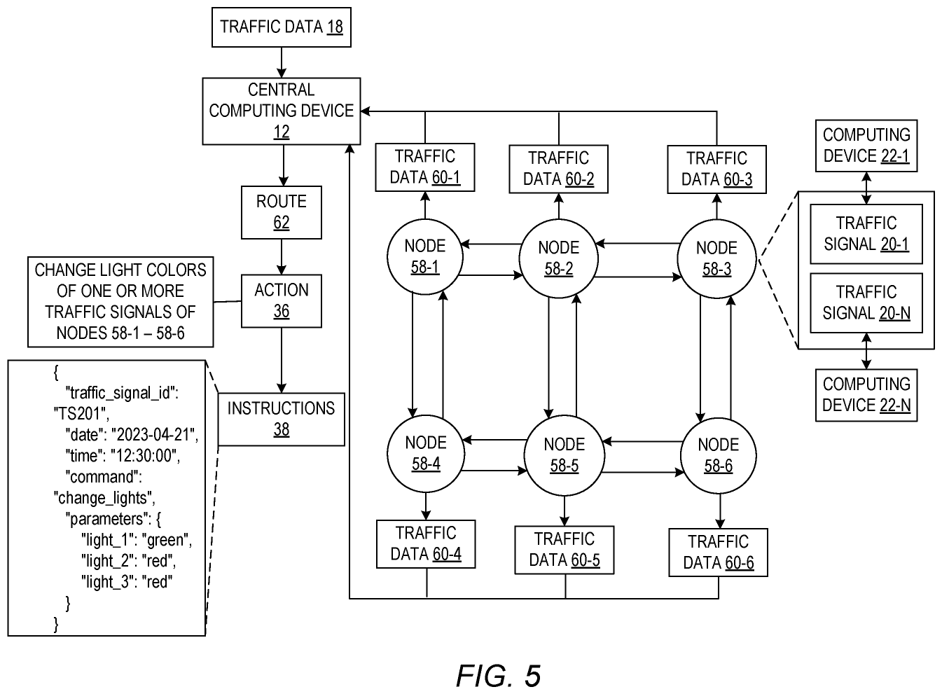

FIG. 5 is a block diagram of the computing system of FIG. 1 for real-time traffic management using smart traffic signals, according to one example. Elements of FIG. 1 are referenced in describing FIG. 5 for the sake of clarity. In the example of FIG. 5, the central computing device 12 may determine the action 36 for each traffic signal of the traffic signals 20 to take by determining that an intersection is blocked based on the traffic data 18. The intersection may be an intersection from among a plurality of intersections 58-1-58-6 (collectively, intersections 58) and each intersection of the intersections 58 may include one or more of the traffic signals 20. For instance, intersection 58-1 may include traffic signal 20-1 and traffic signal 20-2. The central computing device 12 can determine that the intersection is blocked by obtaining the traffic images 40 and/or the traffic speed 56 that correspond to the traffic signals in the intersection from the traffic data 18 and determine, such as by the machine-learning model 42, that the traffic congestion level 46 is high based on the traffic images 40 and/or the traffic speed 56. The central computing device 12 may receive traffic data 60 (e.g., traffic data 60-1-60-6) for each traffic signal in the blocked intersection and for each traffic signal that is adjacent to the blocked intersection from the computing devices 22. The central computing device 12, such as by the machine-learning model 42, can generate a route 62 based on the traffic data 60 for each traffic signal in the blocked intersection and for each traffic signal that is adjacent to the blocked intersection in order to divert traffic away from the blocked intersection. The central computing device 12 may determine that the action 36 is to change the light colors of one or more of the traffic signals 20 in the intersections 58 in order to follow the route 62, and generate the instructions 38 to send to each traffic signal of the traffic signals 20 (e.g., to the computing devices 22) in the intersections 58 based on the route 62. The instructions 38 for the traffic signals 20 in the intersections 58 that are to change light colors in order to follow the route 62 can include a command to change the lights (i.e., the action 36) and the color to change the light. In some implementations, the instructions 38 can include a time for each traffic signal in the intersections 58 in the route 62 to change light colors and the color to change the light at that time in order to follow the route 62 and reduce traffic congestion around the blocked intersection, such as keeping a traffic signal light green for a longer time before turning the light red at some traffic signals in the blocked intersection.

For example, the central computing device 12 may determine that intersection 58-3 with traffic signal 20-1, traffic signal 20-2, and traffic signal 20-3 is blocked based on the traffic data 18 that corresponds to the traffic signals in the intersection. The central computing device 12 can receive traffic data 60-3 from traffic signal 20-1, traffic signal 20-2, and traffic signal 20-3 in the blocked intersection, traffic data 60-2 from the traffic signals in intersection 58-2 which is adjacent to the blocked intersection 58-3, and traffic data 60-6 from the traffic signals in intersection 58-6 which is adjacent to the blocked intersection 58-3. The blocked intersection 58-3 can be separated from the unblocked intersections based on the traffic data 60, and the central computing device 12, such as by the machine-learning model 42, can create a path (e.g., the route 62) to divert traffic away from the blocked intersection 58-3 and determine the action 36 and the instructions 38 to send to the traffic signals in the blocked intersection 58-3 and the adjacent intersections (e.g., the intersection 58-2, the intersection 58-6) based on the path.

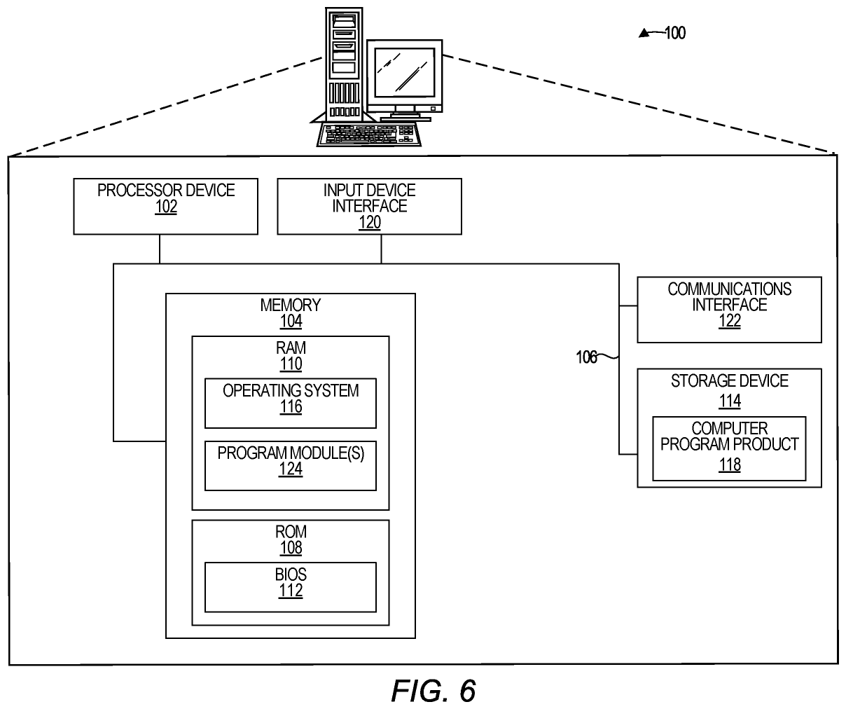

FIG. 6 is a block diagram of a computing device 100, such as the central computing device 12 of the computing system 10, suitable for implementing examples according to one example. The computing device 100 may comprise any computing or electronic device capable of including firmware, hardware, and/or executing software instructions to implement the functionality described herein. The computing device 100 includes a processor device 102, such as the processor device 16, a system memory 104, such as the memory 14, and a system bus 106. The system bus 106 provides an interface for system components including, but not limited to, the system memory 104 and the processor device 102. The processor device 102 can be any commercially available or proprietary processor.

The system bus 106 may be any of several types of bus structures that may further interconnect to a memory bus (with or without a memory controller), a peripheral bus, and/or a local bus using any of a variety of commercially available bus architectures. The system memory 104 may include non-volatile memory 108 (e.g., read-only memory (ROM), erasable programmable read-only memory (EPROM), electrically erasable programmable read-only memory (EEPROM), etc.), and volatile memory 110 (e.g., random-access memory (RAM)). A basic input/output system (BIOS) 112 may be stored in the non-volatile memory 108 and can include the basic routines that help to transfer information between elements within the computing device 100. The volatile memory 110 may also include a high-speed RAM, such as static RAM, for caching data.

The computing device 100 may further include or be coupled to a non-transitory computer-readable storage medium, such as a storage device 114, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 114 and other drives associated with computer-readable media and computer-usable media may provide non-volatile storage of data, data structures, computer-executable instructions, and the like.

A number of modules can be stored in the storage device 114 and in the volatile memory 110, including an operating system 116 and one or more program modules 124, which may implement the functionality described herein in whole or in part. All or a portion of the examples may be implemented as a computer program product 118 stored on a transitory or non-transitory computer-usable or computer-readable storage medium, such as the storage device 114, which includes complex programming instructions, such as complex computer-readable program code, to cause the processor device 102 to carry out the steps described herein. Thus, the computer-readable program code can comprise software instructions for implementing the functionality of the examples described herein when executed on the processor device 102. The processor device 102 may serve as a controller, or control system, for the computing device 100 that is to implement the functionality described herein.

An operator, such as a user, may also be able to enter one or more configuration commands through a keyboard (not illustrated), a pointing device such as a mouse (not illustrated), or a touch-sensitive surface such as a display device (not illustrated). Such input devices may be connected to the processor device 102 through an input device interface 120 that is coupled to the system bus 106 but can be connected by other interfaces such as a parallel port, an Institute of Electrical and Electronic Engineers (IEEE) 1394 serial port, a Universal Serial Bus (USB) port, an IR interface, and the like. The computing device 100 may also include a communications interface 122 suitable for communicating with the network as appropriate or desired. The computing device 100 may also include a video port (not illustrated) configured to interface with the display device (not illustrated), to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a central computing device, traffic data from a plurality of traffic signals;
determining, by the central computing device, an action for each traffic signal of the plurality of traffic signals to take based on the traffic data; and
sending, by the central computing device to the plurality of traffic signals, instructions corresponding to the action for each traffic signal of the plurality of traffic signals to take.

2. The method of claim 1, further comprising:
prior to receiving the traffic data, obtaining, by computing devices communicatively coupled to each traffic signal of the plurality of traffic signals, the traffic data based on radar data and camera data corresponding to the plurality of traffic signals.

3. The method of claim 1, further comprising:
subsequent to sending the instructions, performing, by computing devices communicatively coupled to each traffic signal of the plurality of traffic signals, the action based on the instructions.

4. The method of claim 1, wherein determining the action for each traffic signal of the plurality of traffic signals to take based on the traffic data comprises:
determining, based on the traffic data, that an intersection comprising one or more of the plurality of traffic signals is blocked;
receiving traffic data for each traffic signal in the intersection and traffic data for each traffic signal adjacent to the intersection; and
generating a route based on the traffic data for each traffic signal in the intersection and the traffic data for each traffic signal adjacent to the intersection;
wherein the action for each traffic signal of the plurality of traffic signals to take comprises changing light colors of one or more traffic signals of the plurality of traffic signals based on the route.

5. The method of claim 4, further comprising:
subsequent to generating the route, determining the instructions to send to the one or more traffic signals of the plurality of traffic signals, wherein the instructions comprise a command to change the light colors of the one or more traffic signals and a color for each light to be set.

6. The method of claim 4, wherein determining, based on the traffic data, that the intersection comprising one or more of the plurality of traffic signals is blocked comprises:
obtaining, from the traffic data, one or more traffic images corresponding to the plurality of traffic signals;
determining, by a machine-learning model, an amount of vehicles in the one or more traffic images; and
determining, by the machine-learning model based on the amount of vehicles in the one or more traffic images, that the intersection comprising one or more of the plurality of traffic signals is blocked.

7. The method of claim 1, wherein determining the action for each traffic signal of the plurality of traffic signals to take based on the traffic data comprises:
obtaining, from the traffic data, one or more traffic images corresponding to the plurality of traffic signals;
determining, by a machine-learning model, an amount of vehicles in the one or more traffic images; and
determining, by the machine-learning model based on the amount of vehicles in the one or more traffic images, a traffic congestion level;
wherein the action is based on the traffic congestion level.

8. The method of claim 7, further comprising:
determining, based on the traffic congestion level, that the action for each traffic signal of the plurality of traffic signals to take is changing light colors of one or more traffic signals of the plurality of traffic signals; and
generating the instructions to send to each of the one or more traffic signals of the plurality of traffic signals, wherein the instructions comprise a command to change the light colors of the one or more traffic signals and a color for each light to be set.

9. The method of claim 8, further comprising:
generating a route based on the traffic data and the traffic congestion level;
wherein generating the instructions to send to each of the one or more traffic signals of the plurality of traffic signals is based on the route.

10. The method of claim 9, further comprising:
receiving updated traffic data from the plurality of traffic signals;
determining, based on the updated traffic data, an updated traffic congestion level;
generating an updated route based on the updated traffic data and the updated traffic congestion level;
determining, based on the updated route, that the action for each traffic signal of the plurality of traffic signals to take is changing light colors of one or more traffic signals of the plurality of traffic signals; and
generating, based on the updated route, the instructions to send to each of the one or more traffic signals of the plurality of traffic signals, wherein the instructions comprise a command to change the light colors of the one or more traffic signals and a color for each light to be set.

11. The method of claim 1, wherein determining the action for each traffic signal of the plurality of traffic signals to take based on the traffic data comprises:
obtaining, from the traffic data, a traffic speed corresponding to each traffic signal of the plurality of traffic signals;
determining, by a machine-learning model based on the traffic speed, a traffic congestion level;
determining, based on the traffic congestion level, that the action for each traffic signal of the plurality of traffic signals to take is changing light colors of one or more traffic signals of the plurality of traffic signals; and
generating, by the machine-learning model, the instructions to send to each of the one or more traffic signals of the plurality of traffic signals, wherein the instructions comprise a command to change the light colors of the one or more traffic signals and a color for each light to be set.

12. The method of claim 1, wherein determining the action for each traffic signal of the plurality of traffic signals to take based on the traffic data comprises:
obtaining, from the traffic data, one or more traffic images corresponding to the plurality of traffic signals;
determining, by a machine-learning model, an amount of vehicles in the one or more traffic images;
obtaining, from the traffic data, a traffic speed corresponding to each traffic signal of the plurality of traffic signals;
determining, by the machine-learning model based on the amount of vehicles in the one or more traffic images and the traffic speed, a traffic congestion level;
determining, based on the traffic congestion level, that the action for each traffic signal of the plurality of traffic signals to take is changing light colors of one or more traffic signals of the plurality of traffic signals; and
generating, by the machine-learning model, the instructions to send to each of the one or more traffic signals of the plurality of traffic signals, wherein the instructions comprise a command to change the light colors of the one or more traffic signals and a color for each light to be set.

13. The method of claim 1, wherein determining the action for each traffic signal of the plurality of traffic signals to take based on the traffic data comprises:
obtaining, from the traffic data, a date and a time, wherein the date and the time correspond to a current date and a current time; and
determining, by a machine-learning model based on the date and the time, the action for each traffic signal of the plurality of traffic signals to take;
wherein the machine-learning model comprises a machine-learning model trained on prior traffic data from the plurality of traffic signals.

14. The method of claim 1, wherein sending the instructions corresponding to the action for each of traffic signal of the plurality of traffic signals to take comprises:
determining, based on the traffic data, a traffic signal identifier for each traffic signal of the plurality of traffic signals;
wherein sending the instructions corresponding to the action for each traffic signal of the plurality of traffic signals to take comprises sending the instructions to a traffic signal from among the plurality of traffic signals based on the traffic signal identifier for the traffic signal, wherein the instructions include the traffic signal identifier.

15. The method of claim 1, wherein the traffic data comprises at least one of a traffic signal identifier, a date, a time, a traffic speed, a traffic image URL, and a traffic congestion level.

16. The method of claim 1, wherein the action comprises at least one of changing a light color of one or more traffic signals of the plurality of traffic signals or setting a timer for changing the light color of one or more traffic signals of the plurality of traffic signals.

17. A computing system comprising:
a central computing device comprising a memory and a processor device coupled to the memory, the processor device to:
receive traffic data from a plurality of traffic signals;
determine an action for each traffic signal of the plurality of traffic signals to take based on the traffic data; and
send, to the plurality of traffic signals, instructions corresponding to the action for each of traffic signal of the plurality of traffic signals to take.

18. The computing system of claim 17, further comprising:
computing devices communicatively coupled to each traffic signal of the plurality of traffic signals, the computing devices comprising a memory and a processor device coupled to the memory, the processor device to:
prior to receiving the traffic data, obtain the traffic data based on radar data and camera data corresponding to the plurality of traffic signals; and
subsequent to sending the instructions, perform the action based on the instructions.

19. The computing system of claim 17, further comprising:
a machine-learning model trained on prior traffic data from the plurality of traffic signals, the machine-learning model to:
receive one or more traffic images corresponding to the plurality of traffic signals, wherein the traffic data comprises the one or more traffic images;
determine an amount of vehicles in the one or more traffic images; and
determine, based on the amount of vehicles in the one or more traffic images, a traffic congestion level;
wherein the action is based on the traffic congestion level.

20. A non-transitory computer-readable storage medium that includes computer-executable instructions that, when executed, cause one or more processor devices to:
receive traffic data from a plurality of traffic signals;
determine an action for each traffic signal of the plurality of traffic signals to take based on the traffic data; and
send, to the plurality of traffic signals, instructions corresponding to the action for each traffic signal of the plurality of traffic signals to take.
